(19) United States
(12) Patent Application Publication
(10) Pub. No.: US 2024/0310247 A1
(43) Pub. Date: Sep. 19, 2024

(54) INTRA-BUCCAL MOUNTING DEVICE FOR MOUNTING DEVICE OUTSIDE USER'S MOUTH

(71) Applicant: Luis Stohr, Redondo Beach, CA (US)

(72) Inventor: Luis Stohr, Redondo Beach, CA (US)

(21) Appl. No.: 18/122,609

(22) Filed: Mar. 16, 2023

(51) Int. Cl. G01M 99/00

(52) U.S. Cl. CPC G01M 99/00

(57) ABSTRACT

An intra-buccal mounting device for holding a device outside a user's mouth includes a remaining member and an elongated holding member integrally extended from the remaining member; wherein the remaining member includes a first curve-shaped retaining member outwardly extended from the elongated holding member and a second curved-shaped retaining member outwardly extended from the elongated holding member.

### FIELD OF THE DISCLOSURE

The present disclosure relates to a mechanical device and more particularly to an intra-buccal mounting device, which its performance can be tested using modal dynamics. The intra-buccal mounting device is designed to hold an external battery and circuits that are connected to components at the inner side of the human mouth.

### BACKGROUND OF THE DISCLOSURE

Generally, the human anatomy prioritizes the human head as the main area of the body, wherein the brain has four out of five basic senses which are fully located. The five basic senses are located at the front (or “face”): sight, hearing, smell, and taste. Important inventions, such as the eyeglasses that influence human vision are mounted on the covering side of the face and held by the ears and nose with masks to protect from alter air when inhaling or exhaling, and headphones reproduce sound hanging from the human head. The lower side of the face, where the body's mouth cavity is located, represents functions such as the body's nutrition and breathing. Also, the mouth has functions to communicate verbally, variates sound produced at the throat communication, and expels waste from the body. The mouth is utilized to supply fluids or gases and, ideally, transmit information through bone conduction. Ideally, locating a device and holding chemicals inside the mouth cavity represent a major hazard for the human, simply because the mouth is the gate for important nutrition supplies and is a very active and powerful area of the human body. This invention provides a way to securely fix a device outside the mouth without external holders or belts.

All referenced pate and literature are incorporated herein by reference in their entire, where a definition or use of a term in a reference, which is incorporated by reference herein, is inconsistent or contrary to the definition of that term provided herein, the definition of that term provided herein applies and the definition of that term in the reference does not desires mentioned above may seek to satisfy one or more of the desires mentioned above mentioned above embodiments may obviate one or more of the desires mentioned above, it should be understood that some aspects of the embodiments might not necessarily obviate them.

### BRIEF SUMMARY OF THE DISCLOSURE

In a general implementation, the intra-buccal mounting device for holding a device outside a user's mouth may comprise a remaining member and an elongated holding member integrally extended from the remaining member, wherein the remaining member comprises a first curve-shaped retaining member outwardly extended from the elongated holding member and a second curved-shaped retaining member outwardly extended from the elongated holding member.

In another aspect combinable with the general implementation, the first curve-shaped retaining member and the second curve-shaped retaining member may be configured to be placed inside the user's mouth, and the elongated holding member is configured to be placed outside the user's mouth.

Among the many possible implementations of the intra-buccal mounting device, the elongated holding member comprises a protruded holding member and an exhaust member integrally formed between the protruded holding member and the retaining member, wherein the exhaust member is placed inside the user's mouth.

Further, it is contemplated that the first curve-shaped retaining member and the second curve-shaped retaining member may be extended from a front portion of the elongated holding member towards a direction, and the elongated holding member may be extended towards an opposite direction.

In the alternative, the remaining member and the elongated holding may form a one-piece configuration.

It is still further contemplated that the retaining member comprises an upper peripheral edge and a lower peripheral edge, wherein the elongated holding member is integrally extended from the upper peripheral edge, and the lower peripheral edge is located on an opposite side of the upper peripheral edge.

In one embodiment, the remaining member may be disposed between an outer gum of a lower tooth of the user's mouth and a lower lip of the user's mouth.

In another aspect combinable with the general implementation, the intra-buccal mounting device may further comprise a hanger connected with the retaining member and configured to hook on a lower tooth of the user's mouth.

In another aspect combinable with the general implementation, the intra-buccal mounting device may further comprise a hanger comprising an arc-shaped supporting member configured to contact with an inner gum of a lower tooth in the user's mouth and a pair of connecting members connected to the retaining member.

In another aspect combinable with the general implementation, the intra-buccal mounting device may further comprise a hanger comprising a pair of connecting members having a first connecting member and a second connecting member, wherein the first connecting member is connected to the first curve-shaped retaining member and the second connecting member is connected to the second curved-shaped retaining member.

In another aspect combinable with the general implementation, the intra-buccal mounting device may further comprise a hanger comprising an arc-shaped supporting member, a first connecting member integrally extended from one edge of the arc-shaped supporting member, and a second connecting member integrally extended from an opposite edge of the arc-shaped supporting member.

In another aspect combinable with the general implementation, the arc-shaped supporting member comprises a top peripheral edge and a bottom peripheral edge, wherein the first connecting member is integrally extended from the bottom peripheral edge to form a first receiving cavity and the second connecting member is integrally extended from bottom peripheral edge to form a second receiving cavity.

In another aspect combinable with the general implementation, the intra-buccal mounting device may further comprise a hanger connected to the first curve-shaped retaining member and the second connecting member to form a slot.

In another aspect combinable with the general implementation, the intra-buccal mounting device may further comprise a hanger comprising an arc-shaped supporting member, wherein a lower tooth inside the user's mouth is located between the arc-shaped supporting member and the retaining member.

In another aspect combinable with the general implementation, the device is secured on the elongated holding member and is displaced outside the user's mouth.

In another aspect combinable with the general implementation, the first curve-shaped retaining member is symmetrical to the second curve-shaped retaining member with respect to a central line of the elongated holding member.

In another aspect combinable with the general implementation, the intra-buccal mounting device may further comprise a hanger comprising an arc-shaped supporting member having a middle portion inwardly extended towards a front portion of the elongated holding member.

While this specification contains many specific implementation details, these should not be construed as limitations on the scope of any inventions or of what may be claimed but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases, be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity, only directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of an intra-buccal mounting device according to an aspect of the embodiment.

FIG. 2 is a front view of an intra-buccal mounting device of FIG. 1.

FIG. 3 is a perspective view showing the intra-buccal mounting device being cooperated with a user's mouth.

FIG. 4 is a perspective view of the intra-buccal mounting device according to another aspect of the embodiment.

FIG. 5 illustrates that the intra-buccal mounting device is cooperated with the user's mouth.

FIGS. 6A and 6B are perspective views showing the intra-buccal mounting device with a device mounted thereon according to an aspect of the embodiment.

FIG. 7 is a perspective view showing the intra-buccal mounting device being tested in an experiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

It shall be understood that the term “means,” as used herein, shall be given its broadest possible interpretation by 35 U.S.C., Section 112(f). Accordingly, a claim incorporating the term “means” shall cover all structures, materials, or acts set forth herein and all of the equivalents thereof. Further, the structures, materials, or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used by the definitions set out below.

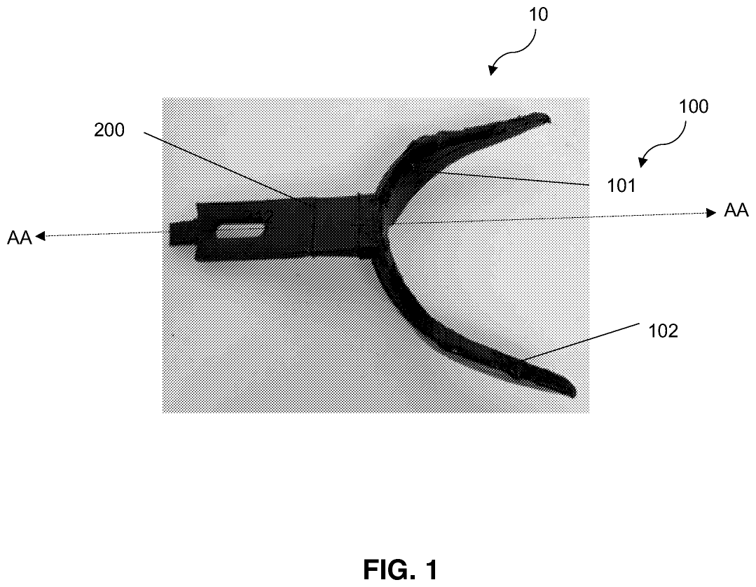

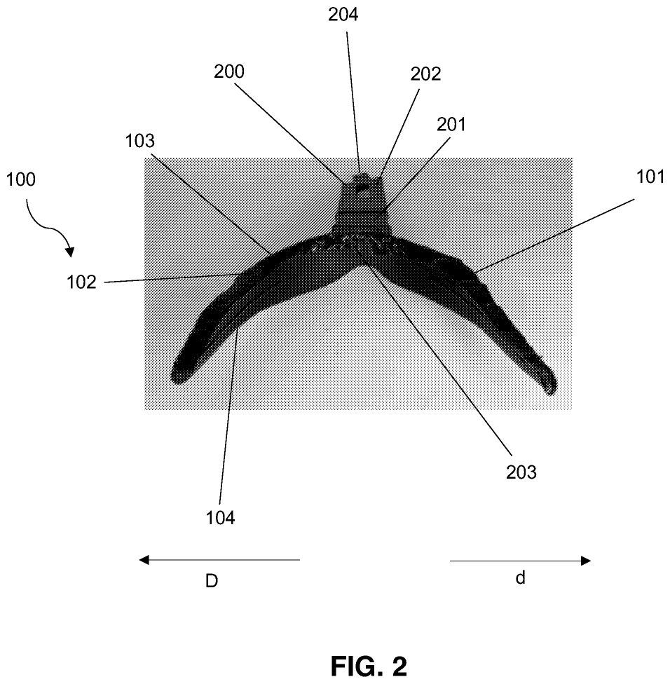

FIGS. 1-2 generally depict an intra-buccal mounting device 10 for holding a device (electronic device) outside a user's mouth according to an aspect of the embodiment.

Referring to FIG. 1, in one embodiment, the intra-buccal mounting device 10 may comprise a remaining member 100 and an elongated holding member 200 integrally extended from the remaining member 100. In still one embodiment, the remaining member 100 and the elongated holding member 200 may form a one-piece configuration.

In still one embodiment, the remaining member 100 may comprise a first curve-shaped retaining member 101 outwardly extended from the elongated holding member 200 to form a first free end and a second curved-shaped retaining member 102 outwardly extended from the elongated holding member 200 to form a second free end. In still one embodiment, the elongated holding member 200 may have a central line “AA”, wherein the first curve-shaped retaining member 101 may be symmetrical to the second curve-shaped retaining member 102 with respect to the central line AA of the elongated holding member 200.

Continuing to FIG. 2, in one embodiment, the first curve-shaped retaining member 101 and the second curve-shaped retaining member 102 may be extended from a front portion 203 of the elongated holding member 200 towards a direction “D,” and the elongated holding member 200 may be extended towards an opposite direction “d.”

In still one embodiment, the retaining member 100 may comprise an upper peripheral edge 103 and a lower peripheral edge 104 formed on the opposite side of the upper peripheral edge 103, wherein the elongated holding member 200 may be extended from the upper peripheral edge 103.

As shown in further details in FIG. 2, the elongated holding member 200 may comprise an exhaust member 201 integrally extended from the front portion 203 of the elongated holding member 200, and a protruded holding member 202 integrally extended from the exhaust member 201 to form a free end 204. In one embodiment, the exhaust member 201 may be formed between the protruded holding member 202 and the front portion 203 of the elongated holding member 200. It should be noted that, in some embodiments, the front portion 203 of the elongated holding member 200 may form on an opposite end of the free end 204 of the elongated holding member 200.

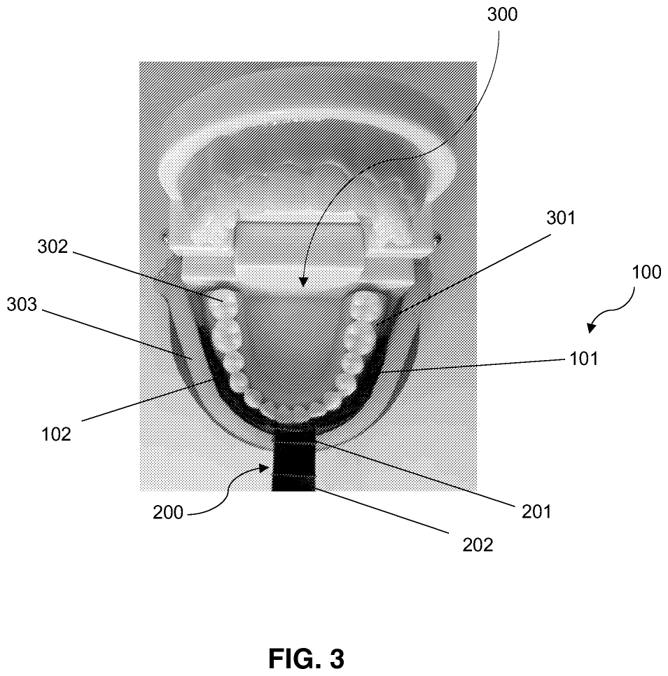

FIG. 3 generally depicts the intra-buccal mounting device being cooperated with the user's mouth 300 according to an aspect of the embodiment.

In one embodiment, the first curve-shaped retaining member 101 and the second curve-shaped retaining member 102 may be configured to be placed inside the user's mouth 300, and the elongated holding member 200 may be configured to be placed outside the user's mouth 300.

In still one embodiment, the exhaust member 201 may be placed inside the user's mouth 300, and the protruded holding member 202 may be placed outside the user's mouth 300, and in such a way, the remaining member 100, including the first curve-shaped retaining member 101 and the second curve-shaped retaining member 102, may be disposed between an outer gum 301 of a lower tooth 302 of the user's mouth 300 and a lower lip 303 of the user's mouth 300. It should be noted that, in some embodiments, the intra-buccal mounting device may not cooperate with an upper tooth of the user's mouth because the gravity may cause the intra-buccal mounting device being falling from the upper tooth of the user's mouth.

In still one embodiment, the first curve-shaped retaining member 101, the second curve-shaped retaining member 102, and the exhaust member 201 of the elongated holding member 200, located inside the user's mouth 300, may be made of non-toxic and friction-resistant materials, such as silicon or rubber.

It should be understood that the above-described materials of the first curve-shaped retaining member 101, the second curve-shaped retaining member 102, and the exhaust member 201 of the elongated holding member 200 are exemplary, and any other materials can be adopted in various embodiments of this disclosure.

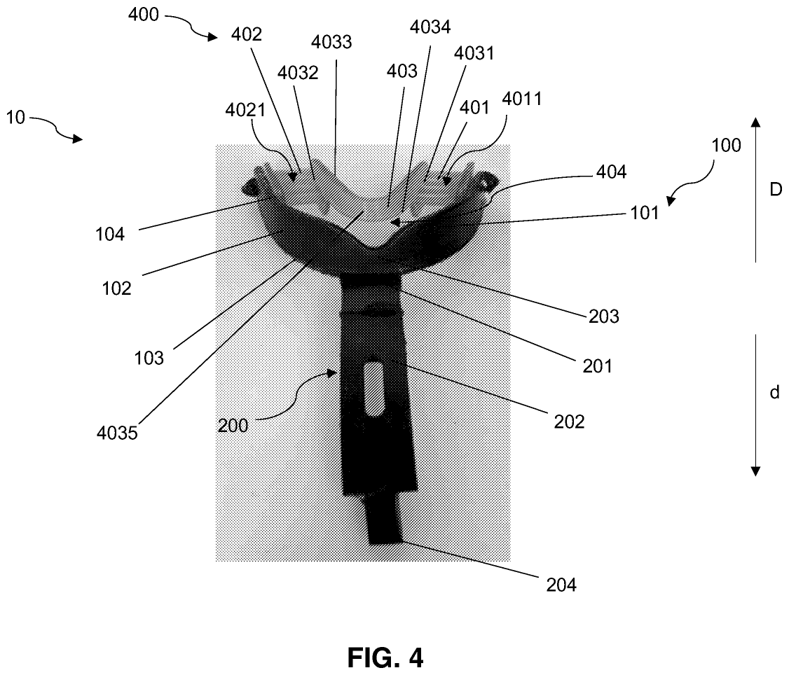

FIG. 4 generally depicts the intra-buccal mounting device for holding the device outside the user's mouth according to another aspect of the embodiment.

Referring to FIG. 4, in one embodiment, the intra-buccal mounting device 10 may comprise the remaining member 100 and the elongated holding member 200 integrally extended from the remaining member 100. In still one embodiment, the remaining member 100 and the elongated holding member 200 may form a one-piece configuration.

In still one embodiment, the remaining member 100 may comprise the first curve-shaped retaining member 101 outwardly extended from the elongated holding member 200 and the second curved-shaped retaining member 102 outwardly extended from the elongated holding member 200. In still one embodiment, the elongated holding member 200 may have the central line AA, wherein the first curve-shaped retaining member 101 may be symmetrical to the second curve-shaped retaining member 102 with respect to the central line AA of the elongated holding member 200.

Continuing to FIG. 4, in one embodiment, the first curve-shaped retaining member 101 and the second curve-shaped retaining member 102 may be extended from the front portion 203 of the elongated holding member 200 towards the direction “D,” and the elongated holding member 200 may be extended towards the opposite direction “d.”

In still one embodiment, the retaining member 100 may comprise the upper peripheral edge 103 and the lower peripheral edge 104 formed on the opposite side of the upper peripheral edge 103, wherein the elongated holding member 200 may be extended from the upper peripheral edge 103 to form a free end 204.

As shown in further details in FIG. 4, the elongated holding member 200 may comprise the exhaust member 201 integrally extended from the front portion 203 of the elongated holding member 200, and the protruded holding member 202 integrally extended from the exhaust member 201 to form the free end 204. In one embodiment, the exhaust member 201 may be formed between the protruded holding member 202 and the front portion 203 of the elongated holding member 200.

In one embodiment, the intra-buccal mounting device 10 may further comprise a hanger 400 connected with the retaining member 100, wherein the hanger 400 may further comprise an arc-shaped supporting member 403 and a pair of connecting members having a first connecting member 401 and a second connecting member 402, wherein the first connecting member 401 may be integrally extended from one edge 4031 of the arc-shaped supporting member 403, and the second connecting member 402 integrally extended from an opposite edge 4032 of the arc-shaped supporting member 403.

In still one embodiment, the first connecting member 401 may be coupled to the first curve-shaped retaining member 101, and the second connecting member 402 may be coupled to the second curved-shaped retaining member 102.

In still one embodiment, the arc-shaped supporting member 403 may comprise a top peripheral edge 4033 and a bottom peripheral edge 4034 formed on the opposite side of the top peripheral edge 4033, wherein the first connecting member 401 may be integrally extended from the one edge 4031 of the arc-shaped supporting member 403 to form a first receiving cavity 4011 and the second connecting member 402 may be integrally extended from the opposite edge 4032 of the arc-shaped supporting member 403 to form a second receiving cavity 4021. In still one embodiment, the bottle peripheral edge 4034 of the arc-shaped supporting member 403 may be integrally extended to the one edge 4031 of the arc-shaped supporting member 403 and the opposite edge 4032 of the arc-shaped supporting member 403.

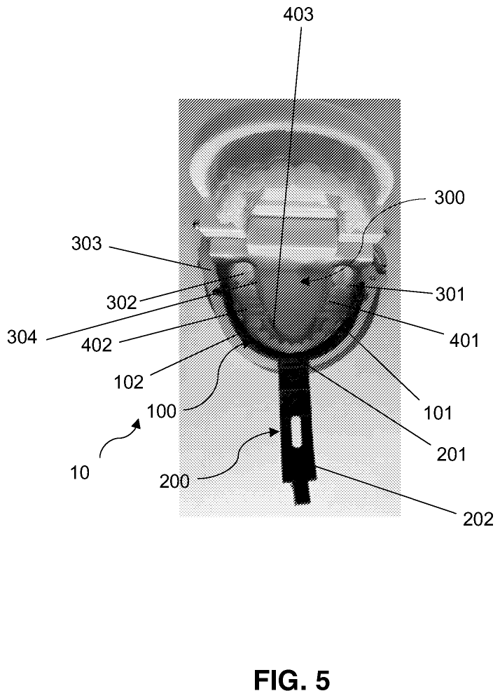

In still one embodiment, the hanger 400, including the first connecting member 401, the second connecting member 402, and the arc-shaped supporting member 403, may be connected to the first curve-shaped retaining member 101 and the second connecting member 102 to form a slot 404, wherein the lower tooth 302 in the user's mouth may be passed through the slot 404 (see FIGS. 4 and 5).

With specific reference to FIG. 4, the arc-shaped supporting member 403 may have a middle portion 4035 inwardly extended towards the front portion 203 of the elongated holding member 200. In some embodiments, the middle portion 4035 of the arc-shaped supporting member 403 may bisect the arc-shaped supporting member 403.

FIG. 5 generally depicts the intra-buccal mounting device cooperating with the user's mouth 300 according to an aspect of the embodiment.

In one embodiment, the first curve-shaped retaining member 101 and the second curve-shaped retaining member 102 may be configured to be placed inside the user's mouth 300, and the elongated holding member 200 may be configured to be placed outside the user's mouth 300.

In still one embodiment, the exhaust member 201 may be placed inside the user's mouth 300, and the protruded holding member may 202 be placed outside the user's mouth 300, and in such a way, the remaining member 100, including the first curve-shaped retaining member 101 and the second curve-shaped retaining member 102, may be disposed between an outer gum 301 of a lower tooth 302 of the user's mouth 300 and a lower lip 303 of the user's mouth 300. It should be noted that, in some embodiments, the intra-buccal mounting device 10 may not cooperate with an upper tooth of the user's mouth 300 because the gravity may cause the intra-buccal mounting device 10 being falling from the upper tooth of the user's mouth.

In still one embodiment, the arc-shaped supporting member 403 may be configured to contact with an inner gum 304 of the lower tooth 302 inside the user's mouth 300 and the pair of connecting members, including the first connecting member 401 and the second connecting member 402, may be connected to the retaining member 100, including the first curve-shaped retaining member 101 and the second curve-shaped retaining member 102, wherein the first connecting member 401 may be coupled to the first curve-shaped retaining member 101 and the second connecting member 402 may be coupled to the second curve-shaped retaining member 102.

Continuing to FIG. 5, the lower tooth 302 inside the user's mouth 300 may be located between the arc-shaped supporting member 403 and the retaining member 100, wherein the first connecting member 401 and the second connecting member 402 may be configured to hook on the lower tooth 302 of the user's mouth 300, and in such a way, the lower tooth 302 of the user's mouth 300 may be received in the first receiving cavity 4011 (see FIG. 4), and the lower tooth 302 of the user's mouth 300 may be received in the second receiving cavity 4021 (see FIG. 4), and in such a manner, the lower tooth 302 may be passed through the slot 404 (see FIG. 4).

It should be noted that in some embodiments, including the embodiments mentioned above, the first curve-shaped retaining member 101, the second curve-shaped retaining member 102, and the exhaust member 201 of the elongated holding member 200, and the hanger 400, located inside the user's mouth 300 may be made of non-toxic and friction resistant materials, such as silicon or rubber.

It should be understood that the above-described materials of the first curve-shaped retaining member 101, the second curve-shaped retaining member 102, the exhaust member 201 of the elongated holding member 200, and the hanger 400 are exemplary and any other materials can be adopted in various embodiments of this disclosure.

In still one embodiment, the elongated holding member 200 of the intra-buccal mounting device 10 may be made of safe, non-toxic, and friction-resistant materials, such as silicon or rubber.

It should be understood that the materials of the elongated holding member 200 are exemplary, and any other materials can be adopted in various embodiments of this disclosure.

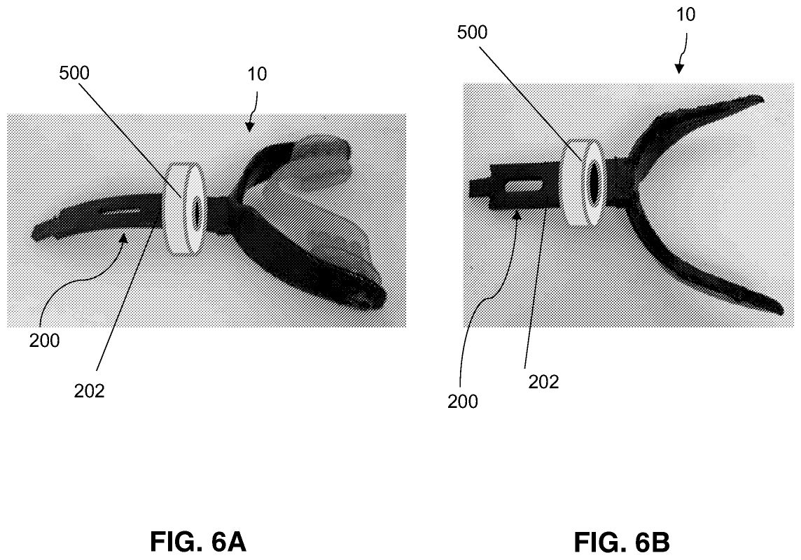

FIGS. 6A and 6B generally show the device 500 being secured on the protruded holding member 202 of the elongated holding member 200 of the intra-buccal mounting device 10 according to an aspect of the embodiment.

According to the embodiments mentioned above, the device 500 may be secured on the elongated holding member 200. For example, the device 500 may be secured on the protruded holding member 202 of the elongated holding member 200 and in such a way, the device 500 is displaced outside the user's mouth.

According to the above-mentioned embodiments, the term “device” means any device that is mounted on the intra-buccal mounting device 10 for purposes including measuring, access to chemicals, fluids, or gasses from or to the human body transmission or reception of electronic, magnetic, or electromagnetic signals, electronic and non-electronic devices, displays and/or cleaning purposes.

### Experimentation Approach

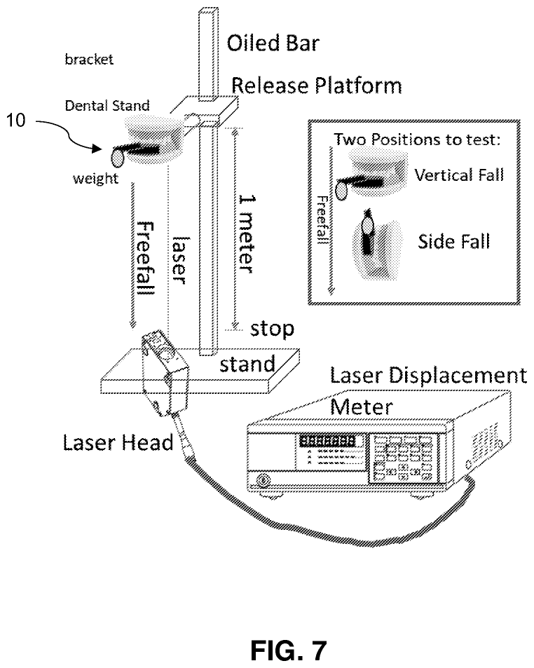

The intra-buccal mounting device (IMB) may utilize a stand to measure how much force would be necessary to detach the IMB device from its original position in the mouth (FIG. 7). A release platform with a dental stand fall guided by a bar that is heavily oiled to reduce any friction between the platform and a bar surface, on a distance of one meter, and making the freefall with different masses amount as variables. The different masses (different weights) would be the different masses of the moving device that could be enough by the IMB device to be kept in the user's mouth. The mass of the platform, the dental stand, and the tested IMB device are known by being measured together with the meter. The meter added on IMB is variable, and the movement of the fall of the meter is recorded by a laser displacement meter through a laser head; in other words, the force limits the IMB device holding the external device. The force may be defined as:

$$F = m * a = \frac{m * 1 meter * 9.8}{( displacement time measured ) \hat{} 2} = \frac{( Mass + Variable weight ) * 9.8}{( displacement time measured ) \hat{} 2} - [ units in Kg m / s \hat{} 2 ]$$

The accepted limit value of the force before the IMB drops during the regular life movements in this experimentation is half of 0.5 joules or 0.25 joules.

Executing the experimentation, the freefall through a one-meter distance and the immediate stop is recorded each time by increasing the mass of the meter that simulates the mass of the device. The laser displacement meter records the trajectory that is added to the presented formula, and a chart is built. On the chart, all process is repeated for human head front movement simulation or vertical fall and side movement simulation or side Fall.

All tests are performed twice, for a first IMB Device, as shown in FIG. 1 (device L), and a second IMB Device, as shown in FIG. 4 (device H). Since the IMB device is positioned inside the mouth, at the area between the gums under the lower front teeth and the labial compartment, a special silicone material may be used to simulate the lower lip of the mouth.

### Experimentation Considerations

The experimentation considerations are listed as follows:
a. For the experimentation, the expected tolerance is assigned to ±5%.
b. The calculation doesn't consider air or sliding bar friction (terminal velocity). The calculator doesn't consider any of these factors since, in practice, the speed exposed is within the expected tolerance.
c. The device is utilized to hold the simulation setup through the shape of the device and the simulator teeth. The teeth simulation is made of plastic to simulate adult teeth' shape. The same conditions are present in the simulation of soft silicone tubes that emulate the human lips that should hold the IMB.
d. Experimentation is performed under a 73.5 deg. F. or 23 deg. C. @ Ave. humidity of 68%.
e. Freefall test is performed 5 times and the smooth results are used on the chart.
f. The experimentation setup simulates the mouth cavity without any mandibular pressure or labial muscles contracted, simulating the tests under a mouth-relaxing condition.
g. The experimentation results will be confirmed if the IMB works as holders of the attached device and up to how much force of the device with the device will stay in position.
h. The Keyence Ultra High Accuracy Laser Displacement Meter model LC-2400 Series has 8 self-calibration procedures performed before the experimentation.
i. The IMB without weight attached to the teeth stand has a weight (mass) of 0.1495 Kg (the second device H, as shown in FIG. 4) or has a weight (mass) of 0.1150 Kg grams (the first device L, as shown in FIG. 1).
j. Calculations to confirm experimentation accuracy: Device L (the first device shown in FIG. 1) without weight, the speed at impact: 4.43 m/s or 15.94 km/h, Time until impact: 0.45 sec., Energy at impact: 1.13 joules. Device H (the second device shown in FIG. 4) without weight, the speed at impact: 4.43 m/s or 15.94 km/h, Time until impact: 0.45 sec., Energy at impact: 1.47 joules. The following chart represents the math calculation of the devices' trajectory:

### CONCLUSIONS

1. Based on the results obtained from experimentation results, the invention represented by Device H for carrying heavier devices and Device L for lighter devices are proven to be functional by performing as expected when holding 0.26 joules and 0.32 joules on position, which is higher than the target of 0.25 joules.
2. Both designs, the second IMB (Device H) and the first IMB (Device L), are proven to hold device mass efficiently under the simulated conditions. Experimentation confirms that the invention devices Device L holds up to 27 grams and Device H holds up to 42 grams. The invention tested proves that the external device having built Bluetooth, a u-processor, two solenoids, plugs, switches, wires, an enclosure, a lead circuit, and a 3.7V-280 mA-h lithium-ion battery with a mass of approx. 25 grams can be used with Device L configuration. Also, since Device H can hold a device with a mass of up to 42 grams having 3 or more 3.7V-280 mA-h lithium-ion batteries with a 5.5 grams mass or 16.5 grams of the total electronic device, wherein the electronic device can be secured on the device H/L to prolong its working time and to reduce battery charging time.
Many alterations and modifications may be made by those having ordinary skill in the art without departing from the spirit and scope of the disclosed embodiments. Therefore, it must be understood that the illustrated embodiments have been set forth only for the purposes of example and should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of an intra-buccal mounting device have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Insubstantial changes from the claimed subject matter as viewed by a person with ordinary skill in the art, now known or later devised, are expressly contemplated as equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be substituted, and what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings but to include by special definition in this specification structure, material, or acts beyond the scope of the commonly defined meanings. Thus if an element can be understood in this specification as including more than one meaning, then its use in a claim must be understood as being generic to all possible meanings supported by the specification and the word itself.

Therefore, the definitions of the words or elements of the following claims include not only the combination of elements set forth but all equivalent structures, materials, or acts for performing the same function in the same way to obtain the same result. Therefore, it is contemplated that an equivalent substitution of two or more elements may be made for any of the elements in the claims below or that a single element may be substituted for two or more elements in a claim. Although elements may be described above as acting in certain combinations and even initially claimed as such, it is to be expressly understood that one or more elements from a claimed combination can in some cases, be excised from the combination and that the claimed combination may be directed to a subcombination or variation of a subcombination.

What is claimed is:

1. An intra-buccal mounting device for holding a device outside a user's mouth, comprising:
a remaining member and an elongated holding member integrally extended from the remaining member; wherein
the remaining member comprises a first curve-shaped retaining member outwardly extended from the elongated holding member and a second curved-shaped retaining member outwardly extended from the elongated holding member.

2. The intra-buccal mounting device of claim 1, wherein the first curve-shaped retaining member and the second curve-shaped retaining member are configured to be placed inside the user's mouth, and the elongated holding member is configured to be placed outside the user's mouth.

3. The intra-buccal mounting device of claim 1, wherein the elongated holding member comprises a protruded holding member, and an exhaust member integrally extended from the protruded holding member and formed between the protruded holding member and the retaining member.

4. The intra-buccal mounting device of claim 3, wherein the exhaust member is placed inside the user's mouth.

5. The intra-buccal mounting device of claim 1, the first curve-shaped retaining member and the second curve-shaped retaining member are integrally extended from a front portion of the elongated holding member towards a direction, and the elongated holding member is integrally extended from the front portion towards an opposite direction.

6. The intra-buccal mounting device of claim 5, wherein the elongated holding member is extended towards the opposite direction to form a free end.

7. The intra-buccal mounting device of claim 1, wherein the remaining member and the elongated holding member form a one-piece configuration.

8. The intra-buccal mounting device of claim 1, the retaining member comprises an upper peripheral edge and a lower peripheral edge, wherein the elongated holding member is integrally extended from the upper peripheral edge, and the lower peripheral edge is located on an opposite side of the upper peripheral edge.

9. The intra-buccal mounting device of claim 1, wherein the remaining member is disposed between an outer gum of a lower tooth of the user's mouth and a lower lip of the user's mouth.

10. The intra-buccal mounting device of claim 1, further comprising a hanger connected with the retaining member and configured to hook on a lower tooth of the user's mouth.

11. The intra-buccal mounting device of claim 1, further comprising a hanger comprising an arc-shaped supporting member configured to contact with an inner gum of a lower tooth in the user's mouth and a pair of connecting members connected to the retaining member.

12. The intra-buccal mounting device of claim 1, further comprising a hanger comprising a pair of connecting members having a first connecting member and a second connecting member, wherein the first connecting member is connected to the first curve-shaped retaining member and the second connecting member is connected to the second curved-shaped retaining member.

13. The intra-buccal mounting device of claim 1, further comprising a hanger comprising an arc-shaped supporting member, a first connecting member integrally extended from one edge of the arc-shaped supporting member, and a second connecting member integrally extended from an opposite edge of the arc-shaped supporting member.

14. The intra-buccal mounting device of claim 13, wherein the arc-shaped supporting member comprises a top peripheral edge and a bottom peripheral edge, wherein the first connecting member is integrally extended from the bottom peripheral edge to form a first receiving cavity and the second connecting member is integrally extended from the bottom peripheral edge to form a second receiving cavity, wherein the one edge and the opposite edge of the arc-shaped supporting member are integrally extended from the bottom peripheral edge of the arc-shaped supporting member.

15. The intra-buccal mounting device of claim 1, further comprising a hanger connected to the first curve-shaped retaining member and the second connecting member to form a slot.

16. The intra-buccal mounting device of claim 1, further comprising a hanger comprising an arc-shaped supporting member, wherein a lower tooth inside the user's mouth is located between the arc-shaped supporting member and the retaining member.

17. The intra-buccal mounting device of claim 1, wherein the device is secured on the elongated holding member and is displaced outside the user's mouth.

18. The intra-buccal mounting device of claim 1, wherein the first curve-shaped retaining member is symmetrical to the second curve-shaped retaining member with respect to a central line of the elongated holding member.

19. The intra-buccal mounting device of claim 1, further comprising a hanger comprising an arc-shaped supporting member having a middle portion inwardly extended towards a front portion of the elongated holding member.
